(19) United States
(12) Patent Application Publication
(10) Pub. No.: US 2026/0259065 A1
(43) Pub. Date: Sep. 3, 2026

(54) NON-INTRUSIVE MULTILAYER FLEXIBLE NANO SENSING INTELLIGENT SYSTEM

(71) Applicant: McLenz SA, Lausanne (CH)

(72) Inventors: Pablo Daniel GENTA, Novara (IT); Ibrahim Abdullah AL-BALOUD, Dhahran (SA)

(73) Assignee: McLenz SA, Lausanne (CH)

(21) Appl. No.: 19/068,761

(22) Filed: Mar. 3, 2025

(51) Int. Cl. G01D 5/14; G01D 5/24; G01F 1/66; G01L 1/12; G01L 9/00

(52) U.S. Cl. CPC G01D 5/142; G01D 5/24; G01F 1/66; G01L 1/12; G01L 9/0001

(57) ABSTRACT

A system comprising a multi-layer, flexible, multi-sensing and data processing device consisting of an assembly of sensors, microprocessors, and communication modules, arranged in articulated pieces linked mechanically, such that said pieces can move in relation to each other. The device comprises a multilayer thin-film composite of flexible sensors and solid-state pieces containing integrated circuits and discreet components. The mobility the pieces provides flexibility to the device, thus allowing to install it on top of, or inside of, the body of a solid structure. The device flexible architecture allows being installed or be part of the body of a structure of complex shape. It further discloses methods to diagnose and predict the integrity of a structure, methods for calculating inner pressure of a structure containing fluids, methods to determine the flow-rate of a fluid moving in a containing structure and methods to model the structure.

### DEFINITIONS

The term “upper” denotes an element disposed physically above a corresponding “lower” element, while the term “lower conversely describes an element disposed physically below a corresponding “upper” element in relation to layers of the device of the present invention. Likewise, the term “axial” refers to an orientation substantially parallel to a primary axis of extension of an element, while the term “radial” refers to an orientation orthogonal the primary axis of extension.

The term “device”, refers to the flexible sensors assembly of the present invention which allows multiple types of sensors, microprocessors, communication components to be linked mechanically, receive and share electrical power and share communication busses by means of a mechanical assembly of articulated parts which as a whole provide flexibility to the entire assembly of components.

The term “piece” or “chip’ refers to supporting material parts made of flexible and non-flexible materials, under given relative ambient conditions, that provide support to the electronic components of the present invention and are linked with other pieces by articulated mechanical links or other flexible links.

The term “structure”, “structure under monitoring”, “structure under measurement” denotes the body of the material entity being measured by the device of the present invention.

The term “layer”, denotes a physical distinguishable arrangement of articulated pieces, membranes or mechanically interconnected supporting materials that provide electrical or mechanical interconnectivity to sensing, microprocessor and communication components of the present invention.

### FIELD OF THE INVENTION

The present invention relates to a multi-layer multi-sensing and intelligent system comprising an arrangement of articulated pieces that support sensors, logic solvers and communication modules, for monitoring, diagnosing and to determine the current and near future state of integrity of structure; along with methods to determine operating conditions of the integrity of the structure under monitoring. The structure under monitoring maybe made of a plurality of materials or combinations of them, carrying or being in contact with other materials in liquid, gaseous or any other state of matter.

### BACKGROUND OF THE INVENTION

In general, embodiments of the invention are directed towards flexible multi-sensing devices that can adapt to the shape of, be installed inside coatings of, be material part of, pipelines, process vessels, storage tanks, compressors, valves, pumps, conduits carrying fluids, civil structures, buildings, bridges, medical prosthetics parts, aircraft structure parts, textiles and biological tissue.

Embodiments of the invention are further related to an intelligent device suitable for diagnosis and prediction of the integrity state of metallic and non-metallic structures of:
a) medical surgical robotic arms and tools,
b) robotic arms parts and mechanisms,
c) civil concrete and non-concrete structures,
d) terrestrial vehicle mechanism parts,
e) wind propelled machine parts including aircraft parts,
f) wearables textiles and non-textile parts,
g) composite parts,
h) additive-manufacturing made parts,
i) combinations of structures in any proportions of the above.

In order to facilitate the description of the algorithms of the system, this disclosure presents devices that, in accordance with some embodiments, can function automatically, manually, or semi-manually.

Specifically, it pertains to a system comprising a plurality of non-intrusive (i.e. non-invasive) sensors, which mounted on articulated and flexible supporting pieces, allow monitoring simultaneously in multiple points, mechanical, environmental, and chemical parameters affecting the integrity and performance of a structure. For instance, pipelines, storage tanks, and process vessels and other containment structures of the kind require sensing technology to ensure their integrity, particularly when such structures are located underground or interact with environmental conditions. These structures are frequently exposed to changes in environmental contaminants, fluctuations of operating conditions, for example, changes in operating pressure and temperature, external forces, soil composition variations that can lead to material fatigue, corrosion, or leakage. Effective monitoring solutions are essential to maintain safety, detect early signs of failure, and perform preventive maintenance. Similarly, civil structures are exposed to the action of multiple forces from other adjacent soil and civil structures, wind load, dynamic loads from vehicles, human action, environmental parameters, such as rain, humidity, sunlight radiation, which affect their integrity. Other similar Conventional methods for monitoring structural health and fluid containment often rely on singular or isolated sensors which measure parameters at discrete singular points and lack the ability of multi-directional sensing, around of and or inside of, the structure being monitored.

Conventional sensors generally require invasive installation procedures that compromise the structure's integrity. Furthermore, traditional devices are not designed to simultaneously measure multiple environmental parameters along multiple points in 3-dimensional arrangements, such as soil composition (i.e, pH, nitrogen, phosphorus, conductivity, redox, humidity), temperature, and underground mechanical pressure. Additionally, the device provides wall thickness, structure surface temperature, pressure wave transmitting modules and receiving sensors which allow calculating internal pressure of structures carrying materials and flow-rate for structures carrying moving substances, thus offering a comprehensive solution for real-time monitoring and predictive analysis.

They also lack the capability to detect and calculate internal fluid pressures based on multi-directional non-invasive sensors that include material and environmental data, limiting their ability to predict structural displacements, fatigue, cracks and leaks.

Several existing technologies have attempted to address structural health monitoring and environmental sensing, but they present various limitations. US20170123531 focuses primarily on detecting relative positions and lacks a comprehensive multi-layered sensing approach capable of monitoring multiple environmental and structural parameters simultaneously. US20220317117 describes a nano-scale bio-sensing system utilizing graphene-based nano-structures, which, while suitable for biological applications, does not provide a scalable solution for monitoring industrial systems or structural integrity at a larger scale. CN109540984 discloses a flexible sensor array designed for real-time bio-monitoring of human sweat but lacks the robust mechanical assembly, industrial durability, and multi-layered structure necessary for harsh environments. US20210137398 introduces a flexible pressure sensor designed for wearable devices, which is limited in its application scope and does not incorporate multiple sensing capabilities for broader industrial or civil use. WO2011127331 discloses a flexible and/or stretchable test data sheet with embedded sensing elements that attach to surfaces via adhesives; however, adhesive-based attachment methods may not provide long-term stability in industrial settings, and the system does not include a mechanically integrated, multi-layered approach for sensing and data processing. While these technologies address specific aspects of sensing and monitoring, they exhibit shortcomings in adaptability, scalability, and integration for comprehensive structural and environmental assessment.

### SUMMARY OF THE INVENTION

The invention described herein consists of a multi-layer, flexible device that integrates various sensor types, including ultrasound, microwave, ambient contaminant, and soil condition sensors, along with microprocessors for data processing and means of communications with other data sources and data receiving systems. This device is designed to be installed on, inside of, or near the surface or inside the body of the structure to continuously monitor its integrity. The device can be installed above or underground.

The device disclosed in the present invention possesses a layered and flexible design which allows to be positioned either in close contact with, inside of, or separated from structures of complex shapes, enhancing versatility in installation and allowing taken measurements at multiple points in a 3-dimensional context.

The present invention relates to a multi-layer, flexible, multi-sensing, and data-processing system comprising:
i) a multi-sensing and wave generating device designed for diagnosing and predicting the structural integrity of complex-shaped structures and
ii) logic solvers capable of executing algorithms to process the measurements, algorithms that represent the integrity model of the structure under monitoring and algorithms to diagnose the current integrity of the structure and predict its future condition
The multi-layer, flexible, multi-sensing, and data-processing device is intended for tight installation on or in proximity to structures located above or underground, which may contain or come into contact with fluids, solids, or materials in other states of the matter.

The device comprises a multi-layer thin-film composite made of flexible and solid-state sensors, microprocessors, communication modules, and connecting circuits. These layers incorporate a plurality of sensors, including wall thickness sensors, temperature sensors, soil condition sensors, and ambient air contaminant sensors, for comprehensive environmental and structural monitoring. The device is equipped with nano-sensors that use conductive nanoparticle circuits to generate electromagnetic fields responsive to the structure's dynamic conditions, such as movement, deformation, or pressure changes.

The system includes methods for diagnosing and predicting structural integrity by analyzing data from the sensors and executing algorithms for structural health assessment. It also features methods for calculating the internal pressure of a fluid-containing structure using wall thickness measurements, surface temperature, and reference pressure data. Additionally, the system provides a method for determining the flow rate of a fluid moving within the structure.

By leveraging embedded microprocessors and communication modules, the device can process sensor data in real-time and transmit diagnostic information remotely. This capability allows for proactive monitoring and early detection of potential failures, ensuring safer operation of critical infrastructure.

In accordance with an embodiment of the present invention, a flexible ultrasonic phased array is embedded in one of the layers of the multilayered device, the phased array being electrically connected to a signal processing chip via flexible wires and configured to generate ultrasonic waves for measuring wall thickness in structures such as pipelines and vessels.

In accordance with an embodiment of the present invention, the signal processing chip executes ultrasonic wave signal detection algorithms using a local microprocessor to analyze wall thickness variations, enabling detection of structural integrity changes, corrosion, or material fatigue in real-time.

### BRIEF DESCRIPTION OF THE DRAWINGS

Specific embodiments of the disclosed technology will now be described in detail with reference to the accompanying figures. Like elements in the various figures are denoted by like reference numerals for consistency. The sizes and relative positions of elements in the drawings are not necessarily drawn to scale. For example, the shapes of various pieces, elements and angles are not necessarily drawn to scale, and some of these elements are arbitrarily enlarged and positioned to improve drawing legibility. Further, the particular shapes of the pieces as drawn are not necessarily intended to convey any information regarding the actual shape of the particular elements and have been solely selected for ease of recognition in the drawing.

The teachings of the present invention can be readily understood by considering the following detailed description in conjunction with the accompanying drawings, in which:

FIG. 1 shows a sectional view of detached layers, including the outer mechanical protection layer with hexagonal cavities, solid chips, and interconnection components;

FIG. 2 shows a detailed view of a hexagonal solid chip, including connection pins and sockets;

FIG. 3 shows the top view of a multilayer array comprising sensing microprocessors, communication modules, energy storage, energy generation, and cooling components;

FIG. 4 shows an embodiment illustrating the dynamic compensation of Hall effect sensors to enhance displacement and angle resolution;

FIG. 5 shows a side view illustrating the relative position of a Hall effect sensor in relation to an inductor (coil), a printed circuit board (PCB), and a magnetic source;

FIG. 6 shows a top view of the multilayer device with severed layers to display various internal components, including insulation, circuit, fabric, PCB, cooling, and heat sink layers;

FIG. 7 shows a section view of the multilayer device, highlighting the heat sink and cooling tubing layers;

FIG. 8 provides an isometric view with transparency, showing the arrangement of multiple layers, including the heat sink, flexible solar panel, cooling tubing, PCB, and flexible fabric layers;

FIG. 9 illustrates an isometric sectional view of the device, emphasizing the isolation and mechanical interlocking features provided by hexagonal flexible modules;

FIG. 10 shows a multilayer flexible system consisting of hexagonal flexible and solid pieces with embedded electronic components;

FIG. 11 shows a multilayer flexible system with visible heat sink material, solar panels, cooling tubing, solid electronic chips, flexible fabric, and pass-through holes for chip connections;

FIG. 12 illustrates the flexible fabric layer with mechanical bonding and pass-through rings for socket placement;

FIG. 13 shows the flexible fabric layer with assembled pass-through holes formed by crimped outer and counter rings;

FIG. 14 displays multiple pass-through holes without electrical sockets;

FIG. 15 shows the flexible fabric layer with assembled pass-through holes and solid chip sockets emerging through them;

FIG. 16 shows the rear side of the flexible circuit layer with electrical traces connecting chip sockets;

FIG. 17 illustrates the alignment of solid chip pins with electrical sockets before insertion into the flexible circuit layer;

FIG. 18 provides a close-up of the electrical sockets integrated into the pass-through holes of the flexible fabric layer;

FIG. 19 shows a transparent view of solid chips with inserted pins, sockets, and conductive traces of the flexible circuit layer;

FIG. 20 shows a transparency view revealing the flexible circuit layer, power, and communication traces interconnecting solid chips;

FIG. 21 illustrates the flexible circuit layer's interconnectivity between solid chips without the fabric layer;

FIG. 22 provides a connectivity visualization between solid chips, showing their electrical connections without other structural layers; and

FIG. 23 shows an illustration of the method of the present invention;

FIG. 24 is an illustration representing one of the embodiments of the present invention;

FIG. 25 is an illustration of one of the embodiments of the present invention showing a solid state construction of the chips of FIG. 22;

FIG. 26 is an illustration of one embodiment of the present invention that shows ordered arrays of magnetized metal nanoparticles with large area of coverage on a substrate metallic surface; and

FIG. 27 is an illustration representing one embodiment of the present invention showing a metallic pipeline 112 covered with a wrapping coating.

### DETAILED DESCRIPTION OF THE DRAWINGS

In the following detailed description of embodiments of the disclosure, numerous specific details are set forth in order to provide a more thorough understanding of the disclosure. However, it will be apparent to one of ordinary skill in the art that the disclosure is practiced without these specific details. In other instances, well-known features have not been described in detail to avoid unnecessarily complicating the description.

Throughout the application, ordinal numbers, e.g., first second, third, etc. is used as an adjective for an element i.e., any noun in the application. The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In addition, throughout the application, the terms “first layer”, “second layer” and successive ordinal “layers” are used to describe the position of an element in relation to another element, however, the positioning of the layers do not limit the functions disclosed by the present invention. Those skilled in the art, having benefit of this disclosure, may conceive variations of the position of the layers to achieve the functions disclosed in the present invention.

While embodiments disclosed herein are described with respect to a limited number of embodiments, those skilled in the art, having benefit of this disclosure, will appreciate that other embodiments may be devised which do not depart from the spirit of the invention as disclosed herein.

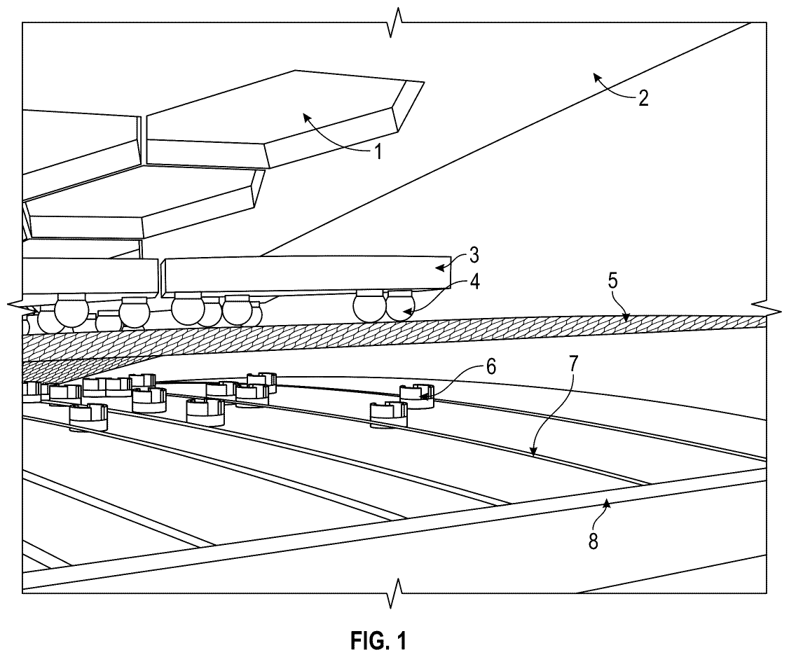

Referring to FIG. 1, the outer flexible layer 2 provides cavities with cutouts such that the hexagonal shape electronic chips 3 fit into the cavities, thus ensuring a gap is maintained among the chips to allow them to rotate on their vertical axis while keeping structural stability. The electronic chips 3 have electric terminals 4 that pass through the flexible fabric layer and connect to sockets 6 attached to the flexible connection layer 8 that provides electrical conductive traces 7 which interconnect electrically the chips to allow chips to communicate with each other across communication buses and sensors mounted on the chips to receive power and connectivity to their outputs with chips carrying microprocessors to perform calculations and signal processing routines.

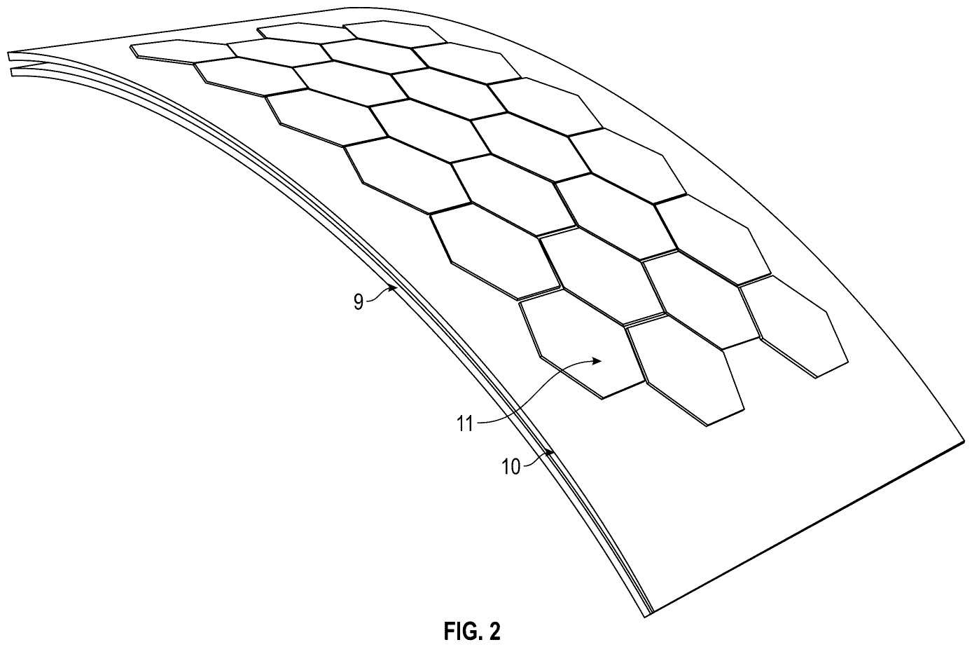

Referring to FIG. 2, this figure shows the flexible outer layer 10 shown in FIG. 1 item2, already assembled and adopting a curved shape along with the chips layer 9 such that electronic chips 11 fit into the hexagonal shape cavities of the outer layer shown in FIG. 1.

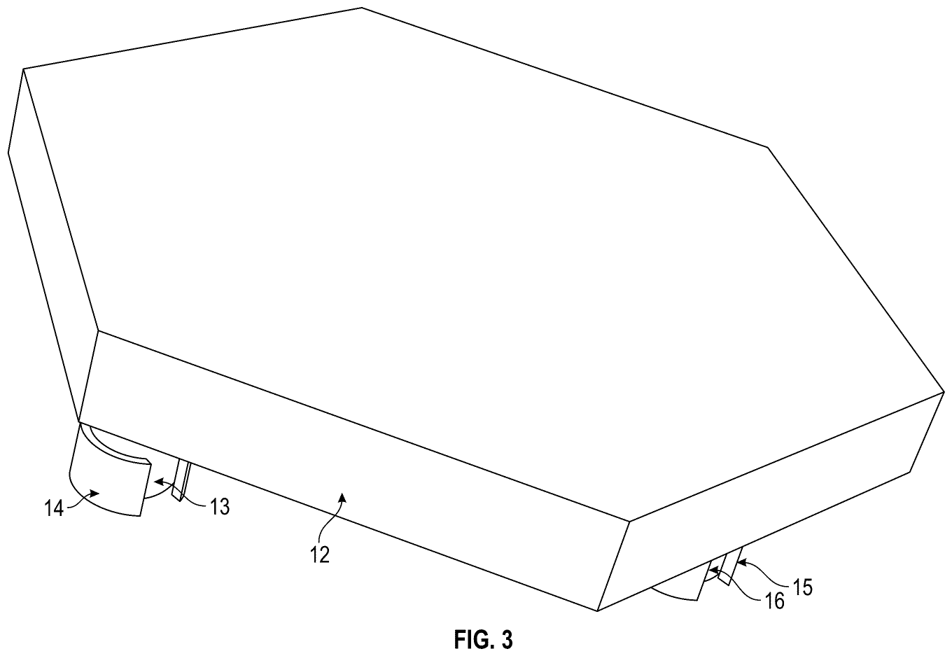

Referring to FIG. 3, the electronic chip 12 of one of the embodiments of the present invention is shown connected by its electrical terminals 13 and 16 to electrical sockets 14 and 15. In FIG. 1 these electrical sockets 14 and 15 of FIG. 3 are attached to the flexible connection layer 8 shown in FIG. 1.

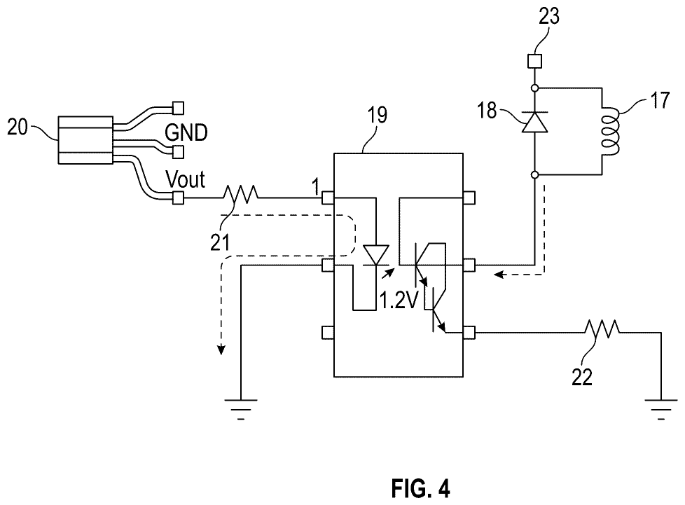

FIG. 4 shows the circuit diagram of the dynamic compensation of the hall effect sensor 20 of the present invention, the polarization resistor 21 connected to an opto-coupler 19 diode. The opto-coupler 19 provides the phase shift necessary to provide the coil 17 with the electrical signal to produce an electromagnetic field in opposition to the fluctuations of the hal effect output signal. The diode 18 allows sudden electrical pulses caused by the reactive response of the coil to return to the other end of the coil 17, thus avoiding damages for overshooting coil signals circulating across the optocoupler transistors. The optocoupler transistors emitters resistor 22 provides the optimum working point of the optocoupler transistors for the signal level provided by the hall effect sensor 20.

The coil 17 is physically mounted in opposition to the hall effect sensor 20 in order to produce the magnetic field in opposition to the hall effect output, thus reducing the overall fluctuations of the hall effect output signal.

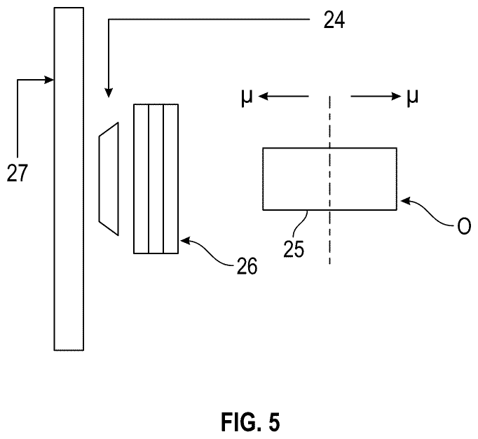

FIG. 5, shows the side view of the relative position of the assembly of components of the dynamic compensation circuit of the hall effect sensor 24. This figure shows the hall effect sensor 24 mounted on a printed circuit board 27, the coil 26 is attached to the measurement face of the hall effect sensor from where electromagnetic field is normally measured in perpendicular direction to the hall effect sensor face. The figure shows a neodymium magnet 25 inserted into the body of the piece of material for which the hall effect sensor 24 will measure relative position (distance) to itself as a function of magnetic field intensity, such that if the body of the piece under measurement moves away from the hall effect sensor 24 the magnetic field of the neodymium magnet attached to it becomes weaker and viceversa. The dynamic compensation circuit allows the hall effect sensor 24 to reduce significantly its own output fluctuations in order to measure nano-scale displacements of a piece where the neodymium magnet 25 is inserted.

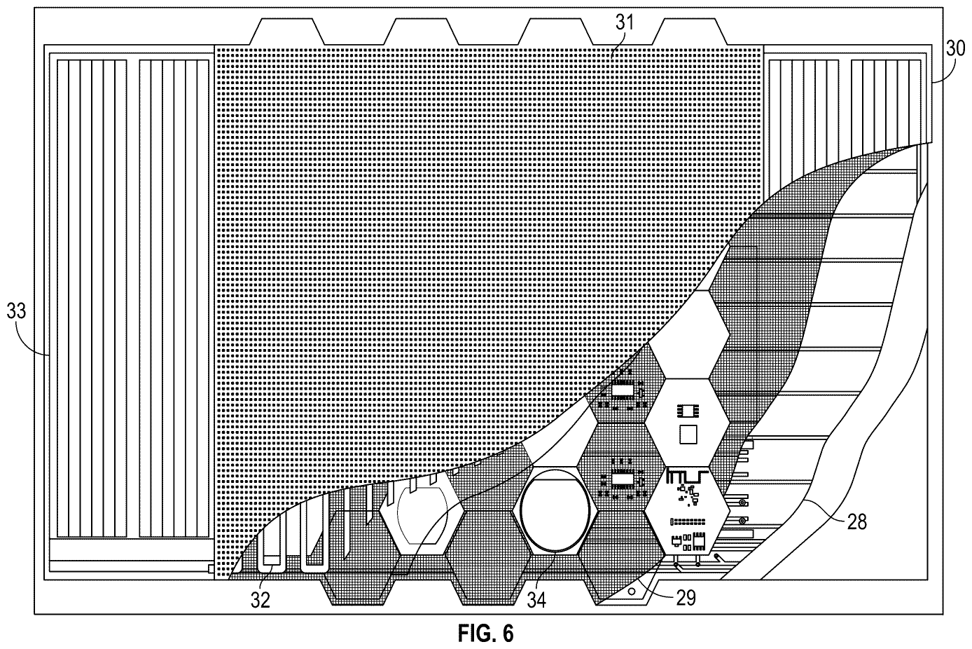

FIG. 6 shows an illustration of progressive sectional views of the flexible layers of one of the embodiments of the present invention. This figure shows the outer flexible heat sink layer 31 textured in a pattern of truncated hexagonal pyramids to allow maximizing the area of contact with the surrounding environment to allow dissipation of the heat generated by electronic chips located in subjacent layers. This figure shows the subjacent cooling flexible tubing 32 attached to the inner face of the flexible outer layer 31. The cooling tubing 32 allows a coolant fluid to circulate all over the surface of the electronic chips 34 and 29. This figure shows a view of a solid electronic chip carrying a battery 34 used to provide electrical power to maintain the inner clock signal and essential functions of the entire flexible multi-sensing system of the present invention. This figure also shows flexible electronic chips 29 where electronic components are mounted on flexible printed circuit boards and covered by flexible electrical insulating coating. Both flexible 29 and solid 34 chips are electrically connected by their electrical terminals to a flexible printed circuit board 28 which provides conductive traces that interconnect electronic chips. This figure also shows flexible solar panels 30 and 33 attached to the sides of the truncated pyramid patterned heat sink layer 31.

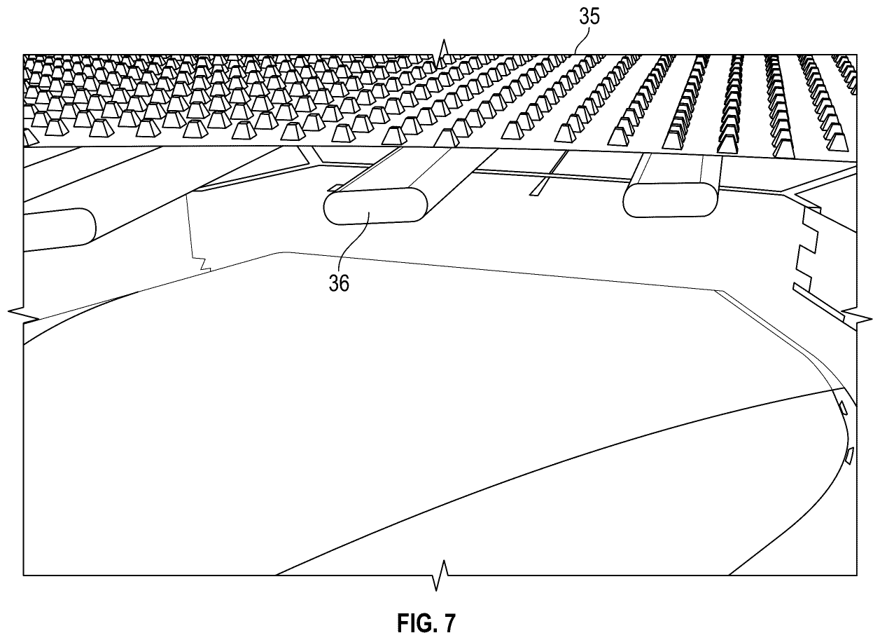

FIG. 7 shows a side view of the truncated pyramid patterned heat sink flexible outer layer 35 and the cooling tubing 36 attached to the inner side of the layer 35.

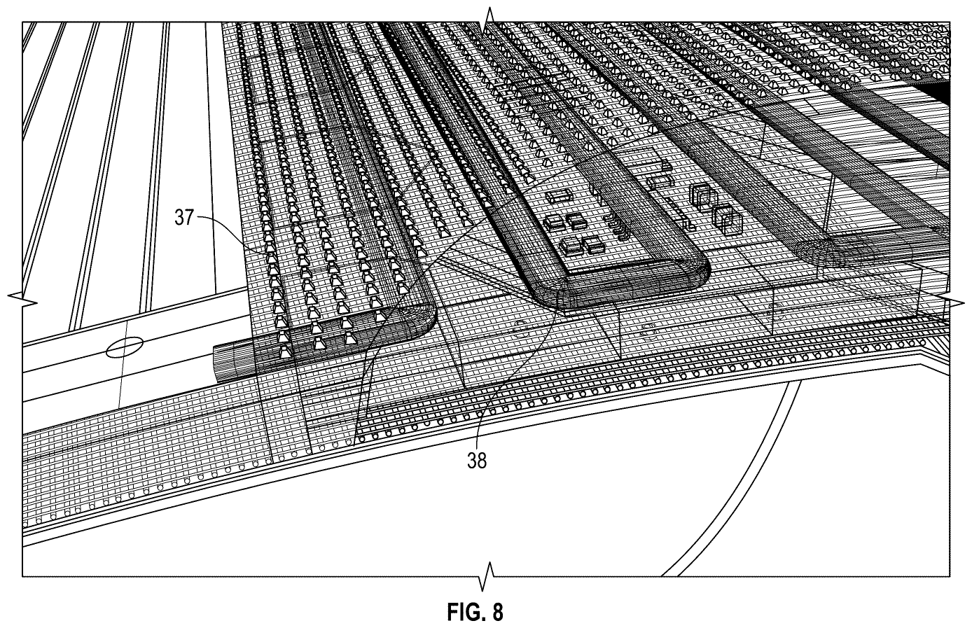

FIG. 8 shows the cooling tubing 38 attached to the flexible heat sink layer 37 shown in relative transparency to allow viewing the routing of the cooling tubing 38 across the entire surface of the electronic chips located underneath.

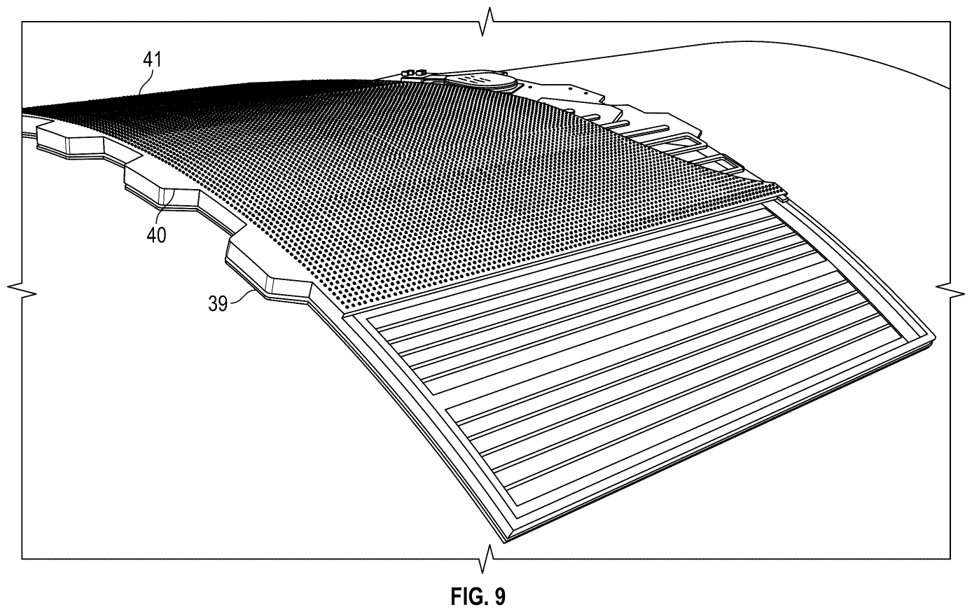

FIG. 9 shows a side view of the closure pieces 40 of the multi-sensing flexible system of the present invention. These closure pieces provide electrical insulation and mechanical protection to the sides of the entire assembly of flexible layers of the present invention. These closure pieces which, surround the perimeter of the entire assembly of flexible layers, are attached to the first insulation layer 39 in contact with the body of material under measurement, for example a process vessel or pipeline.

The perimetral closure pieces 40 are attached on top to the flexible heat sink layer 41 and attached on the bottom side to the first insulation layer 39, thus providing the entire assembly of layers of the present invention with the necessary tightness all around to allow installation under water or in environments containing materials that can cause damages to the components of the layers of the present invention.

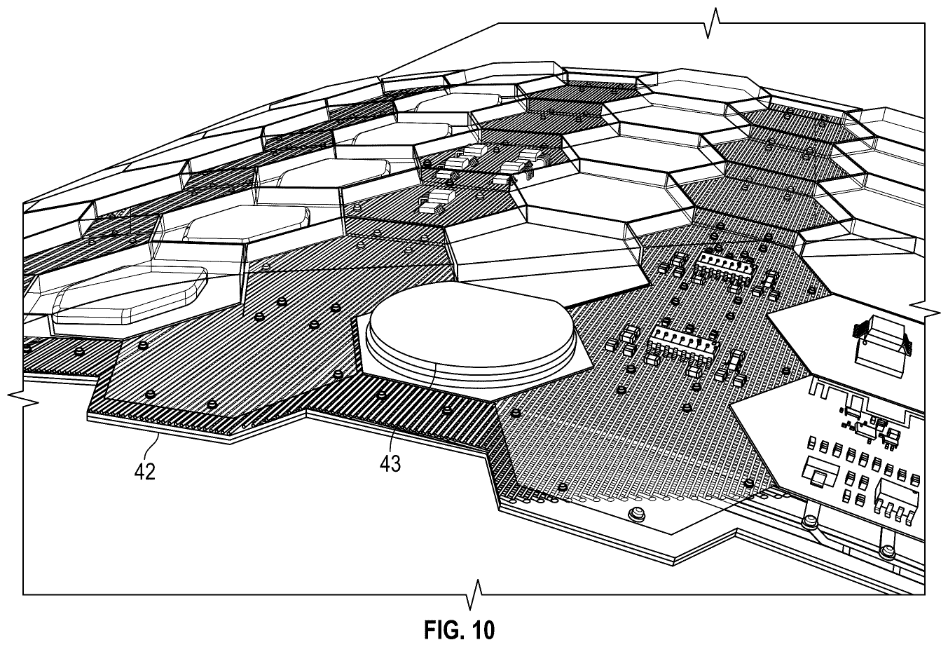

FIG. 10 shows an illustration of a solid chip carrying a solid flat battery 43 such that the hexagonal printed circuit board carrying said battery is supported by a flexible fabric layer 42 showing pass-through holes.

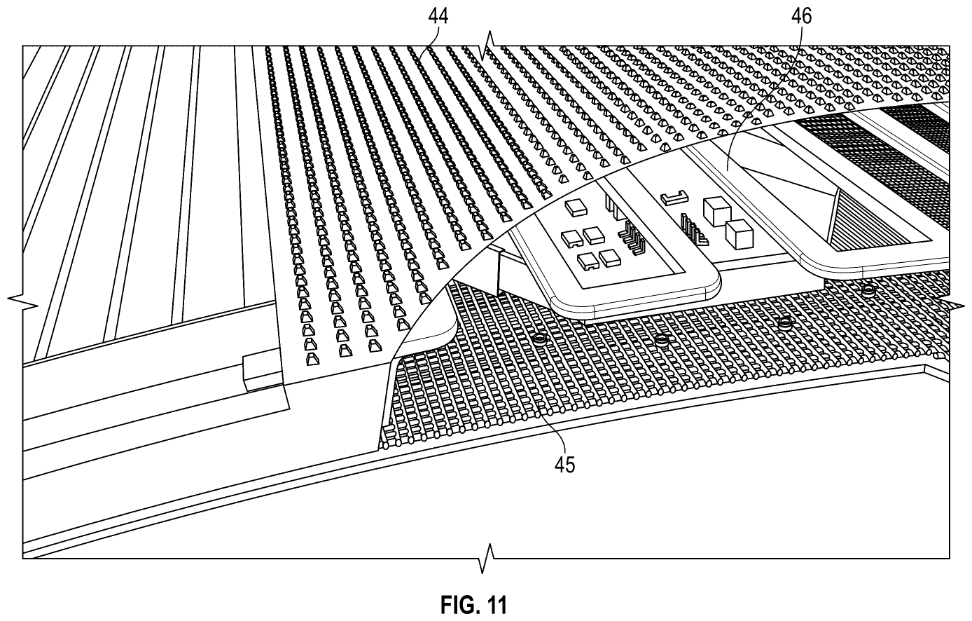

FIG. 11 shows an illustration of the flexible fabric layer 45 containing pass-through bushings to provide mechanical resistance to the entire assembly against overstretching along the horizontal surface of the layers. This figure also shows the cooling tubing 46 and heat sink outer layer 44.

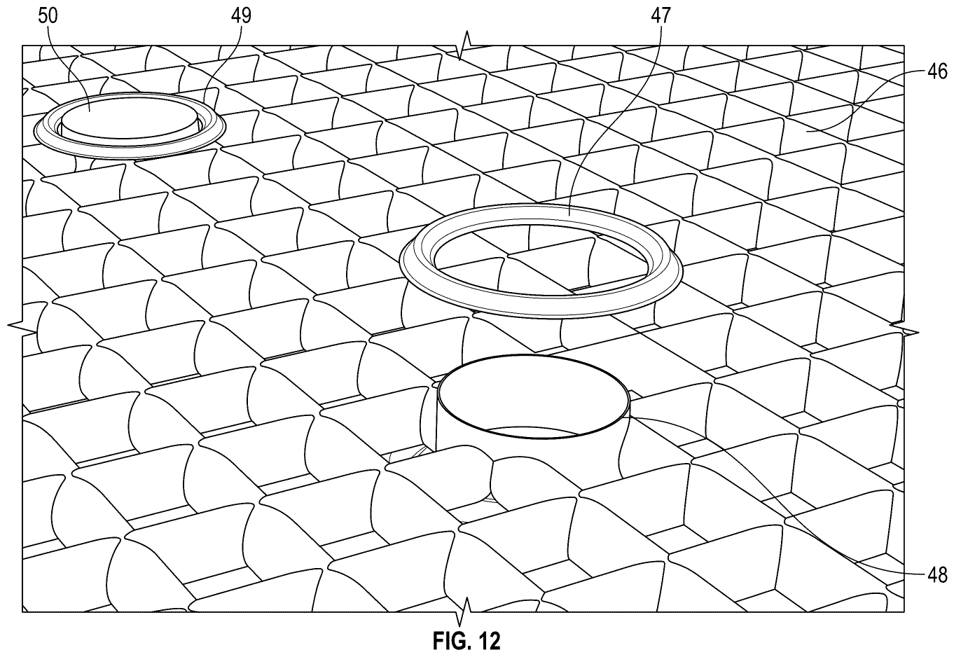

FIG. 12 shows an illustration of the flexible fabric layer 46 of the present invention containing bushings 48 and a holding ring 47 that is attached to the bushing by applying a force on the vertical direction such that the ring expands slightly while the bushing enters to finally get tightly attached to it as shown by the items 49 (holding ring) and 50 (bushing).

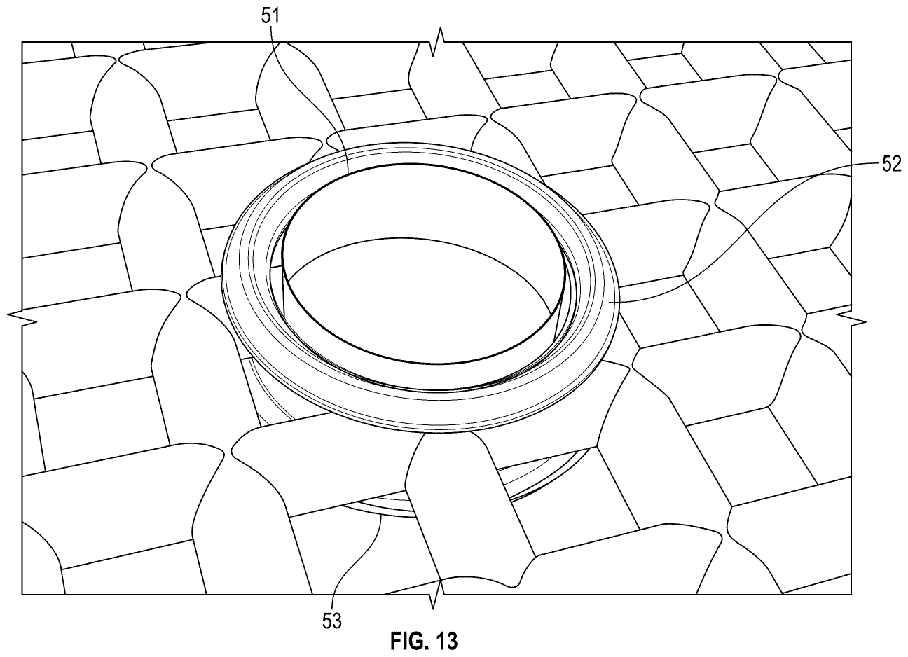

FIG. 13 shows an illustration of the holding ring 52 attached to the bushing 51 on one side if the flexible fabric and the opposite holding ring 53 attached to the other end of the bushing, thus constructing the pass-through holes of the present invention.

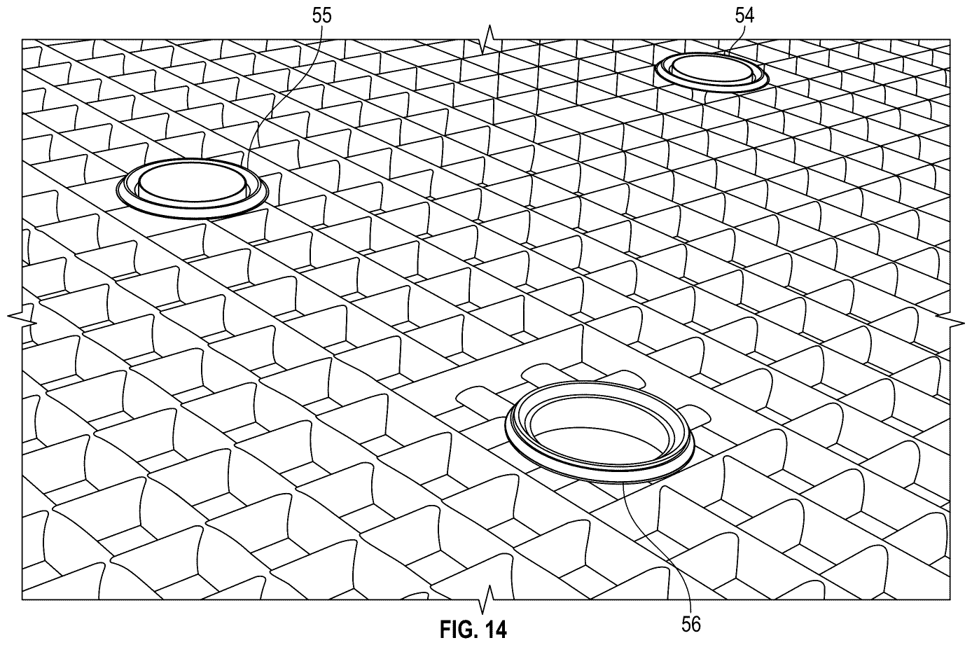

FIG. 14 shows an illustration of the holding rings 54,55 and 56 on one side of the flexible fabric already attached to their respective bushings.

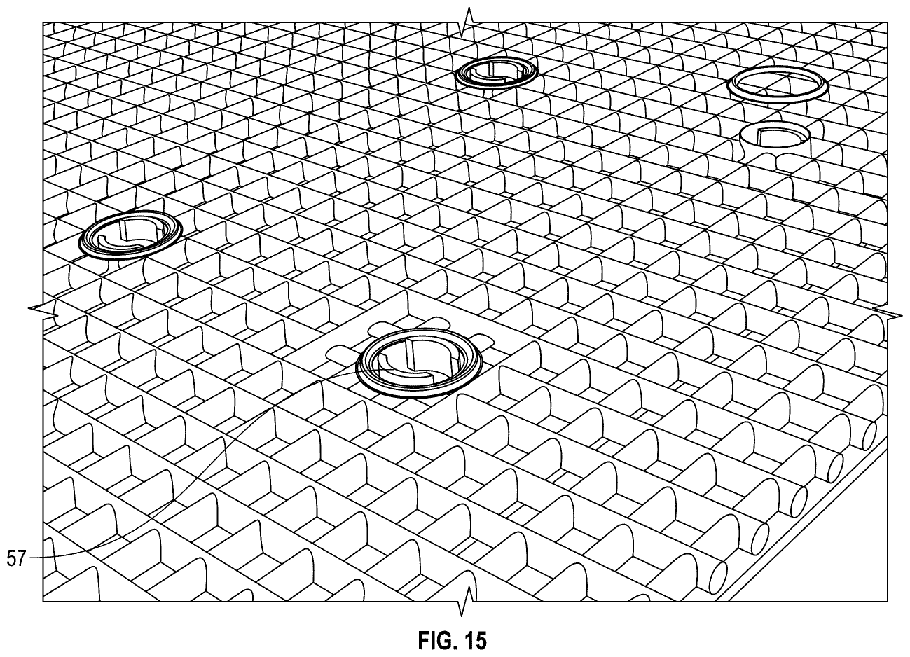

FIG. 15 shows an illustration of the electrical sockets 57 of the flexible printed circuit layer of the present invention, passing through the bushings.

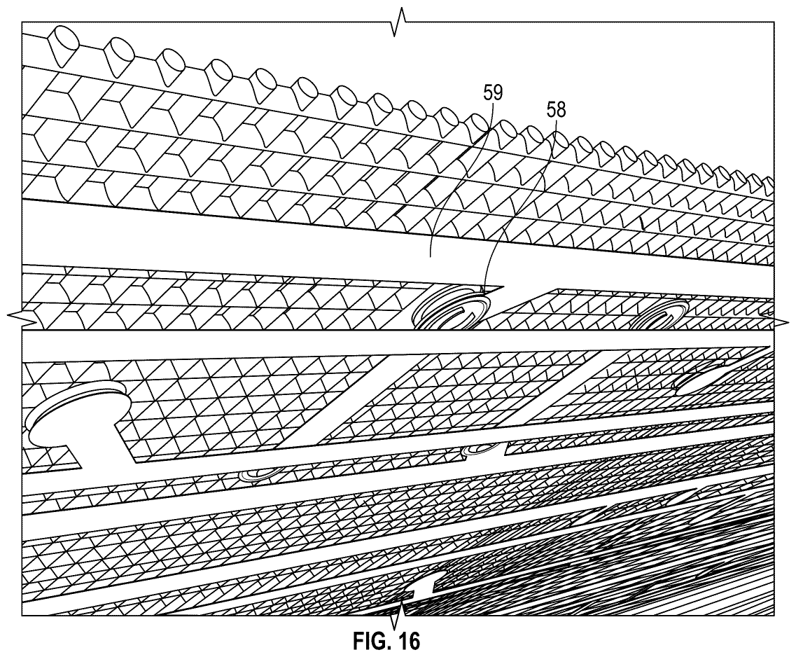

FIG. 16 shows the rear side of the flexible fabric adjacent to the flexible circuit layer 59 of the present invention. The figure show the rear side of the socket for the electrical terminals of the electronic chips.

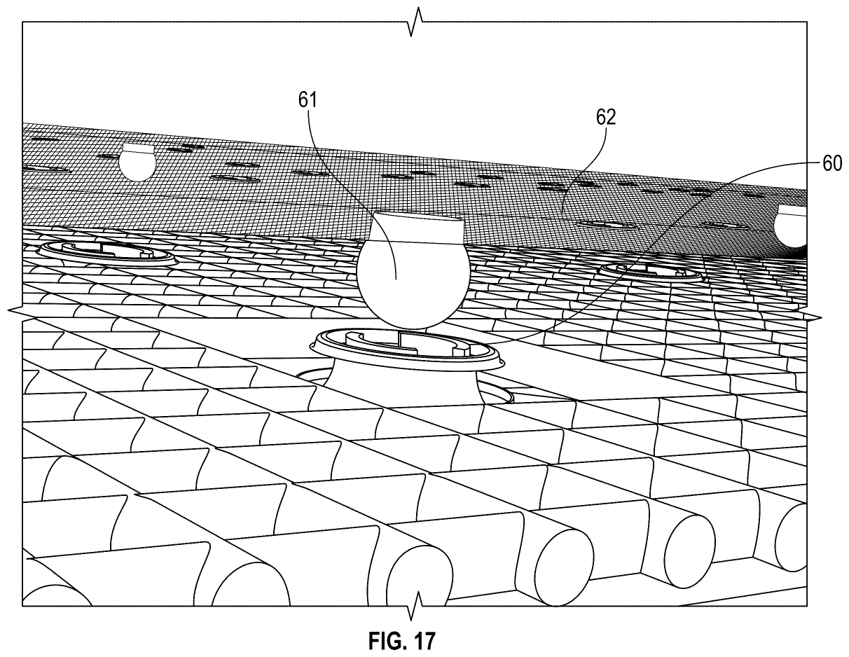

FIG. 17 shows an illustration of the electronic chip 62 with an electrical terminal 61 about to be inserted into the electrical socket 60.

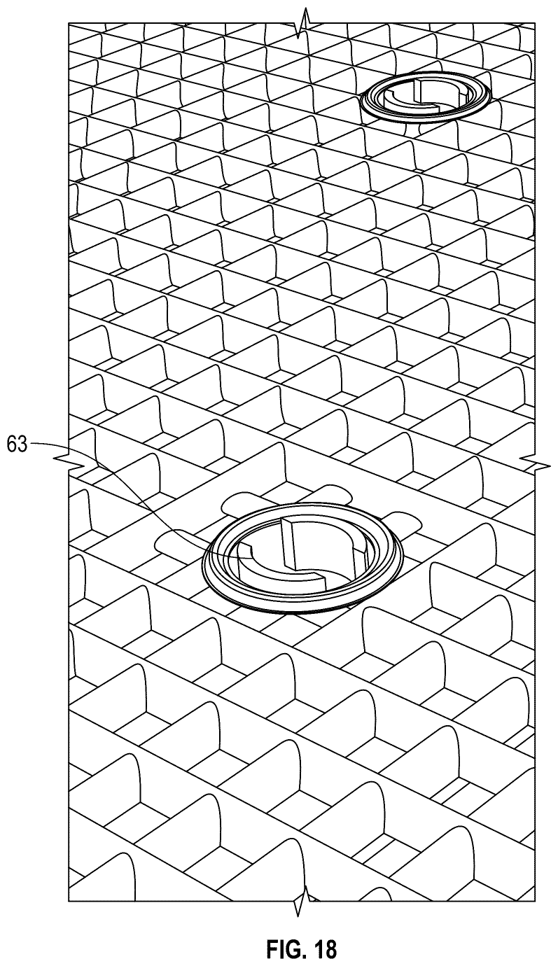

FIG. 18 shows an illustration of the socket 63 passing through the bushings of the flexible fabric layer of the present invention. The socket 63 is attached to the flexible circuit layer.

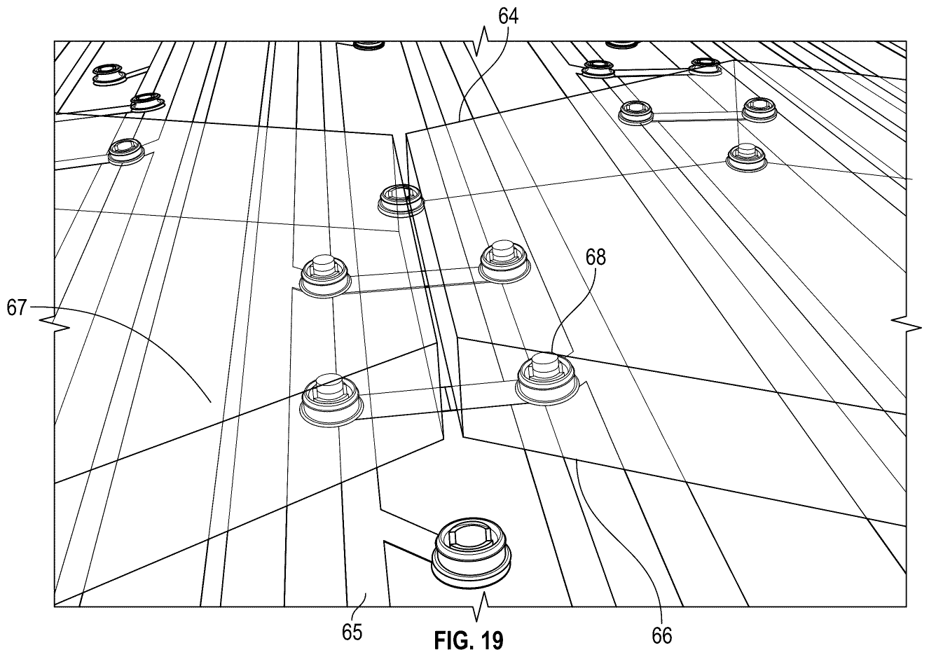

FIG. 19 shows an illustration in transparency of a solid chips 64 and 67, already inserted by their terminal 68 to the flexible circuit layer carrying electrical conductive traces 65 and 66. The fabric layer of FIG. 18 is not shown in this figure.

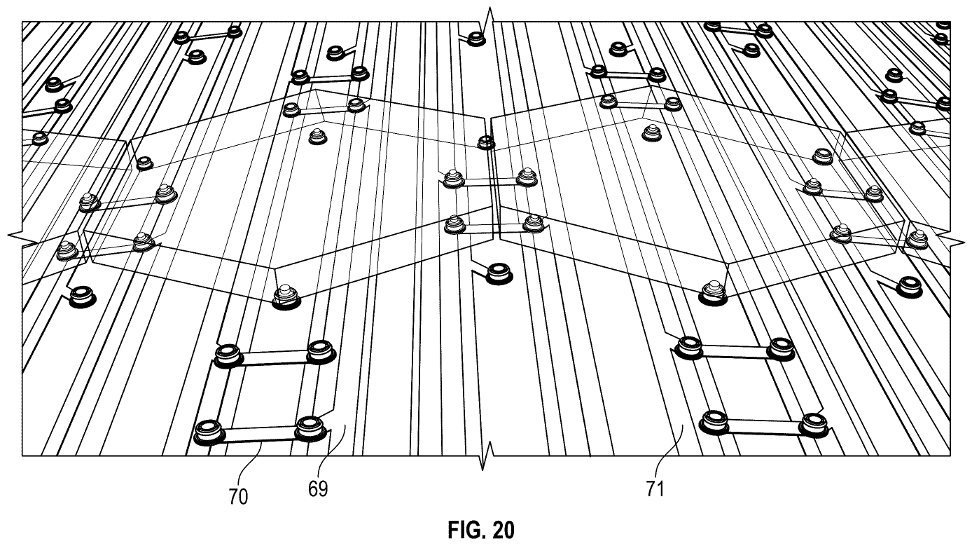

FIG. 20 shows the electrical conductive traces 69,70 and 71 of the flexible printed circuit of the present invention.

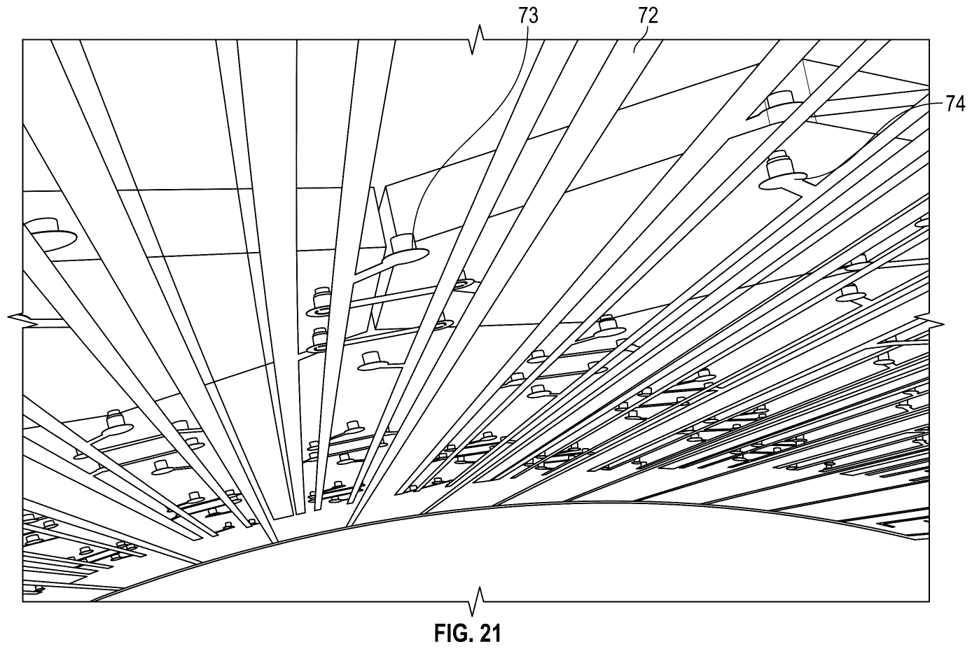

FIG. 21 shows an illustration of the rear side view of the flexible circuit and the joining conductive pads 73 and 74 with the sockets of FIG. 18 of the chips terminals. This figure shows a trace 72 running along the flexible circuit towards other areas of the circuit.

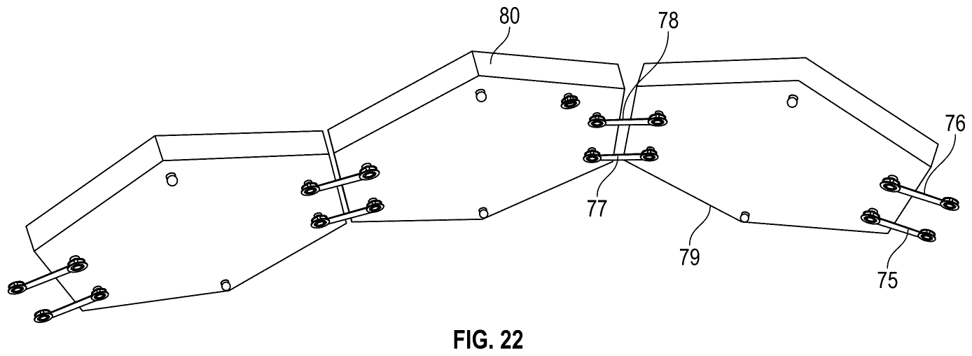

FIG. 22 shows an isolated view of the electronic chips 79 and 80 without showing any other layers but only the specific traces 75,76,77 and 78 of the flexible circuit layer not shown on this figure.

FIG. 22 shows an isolated view of one embodiment of the present invention comprising the electronic chips 79 and 80 without showing any other layers but only the specific traces 75,76,77 and 78 of the flexible circuit layer not shown on this figure. In this embodiment, the chips 79 and 80 are individually sealed to allow submersion into fluids. In yet another embodiment, the sealed chips are embedded into solid materials to become part of the material being measured by the multilayer system of the present invention.

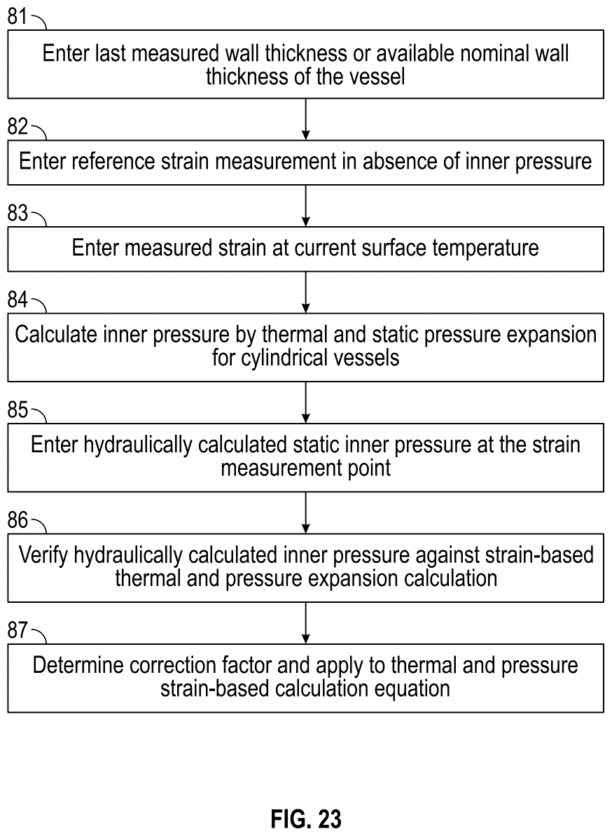

FIG. 23 shows an illustration of the method of the present invention which comprises an initial step 81 for the system to receive from another system or human user:
a) the last measured wall thickness or available nominal wall thickness of the vessel or pipe,
b) Next, at step 82 to receive reference strain measurement in absence of inner pressure,
c) Next, at step 83, to receive the measured strain at the current surface temperature of said vessel,
d) Next, at Step 84, to calculate inner pressure by thermal and static pressure expansion equations for cylindrical vessels
e) Next, at step 85, to receive hydraulically calculated static inner pressure at the strain measurement point
f) Next, at step 86, to verify hydraulically calculated inner pressure against strain-based thermal and pressure expansion calculation
g) Next, at step 87, to determine the correction factor and apply to thermal and pressure strain-based calculation equation

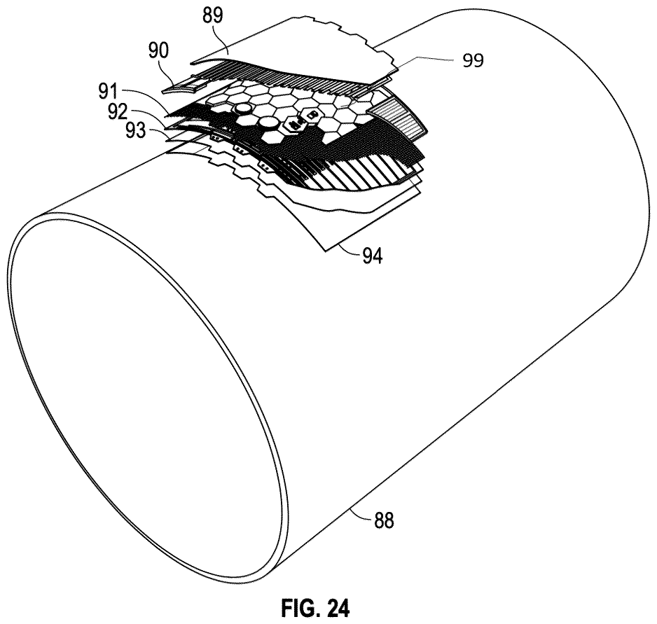

FIG. 24 is an illustration representing one of the embodiments of the present invention, showing a segment of a pipeline or vessel 88, the outer protection layer 89, which holds on the rear side, a thermal compensation serpentine tubing of flexible material to allow cooling or heating the device depending on the settings received by a system or human user, the solar power layer 90 showing on one side parts of a flexible solar panel, the layer 99 of mechanically linked solid state chips carrying electronic integrated circuits and discrete components as well as flexible electronics chips, the layer 91 of flexible fabric to provide mechanical stability to the upper layer and to provide sockets for achieving electrical conductive connections, the layer 92 of electrical traces that interconnect upper and lower layers, the layer 93 carrying sensing components and mechanical sockets to position active devices to be placed magnetically on the surface of the pipe or vessel. The sensing components of the layer 93 interconnect by electrical sockets placed on the layer 92, thus establishing electrical connection with the layer 91 and their components. This FIG. 24 shows the layer 94, which is also shown as insulation layer 39 in FIG. 9.

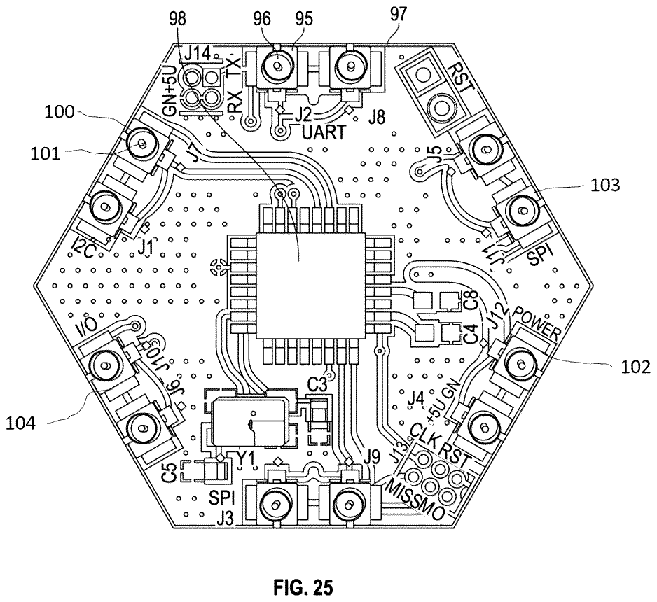

FIG. 25 is an illustration of one of the embodiments of the present invention showing a solid state construction of the chips 79 and 80 of FIG. 22, not showing the outer sealant layer of FIG. 22 chips 79 and 80, but a naked electronic printed circuit board carrying electronic components, including a microprocessor 98, a male electro-mechanical link connector 96, mounted on pad 95, having two contacts 100 and 101 for connecting female ended cables such that said cables connect to other electronic chips, thus providing flexibility to the orientation of every chip printed circuit board in relation to each other. The chip of this embodiment provides a power connector 102, and for example SPI bus connector 103 and other similar connectors 104 on other sides of the perimeter of the chip in order to allow interconnecting data, power and sensor communication busses with other chips carrying solid state microprocessors, memory and sensing devices.

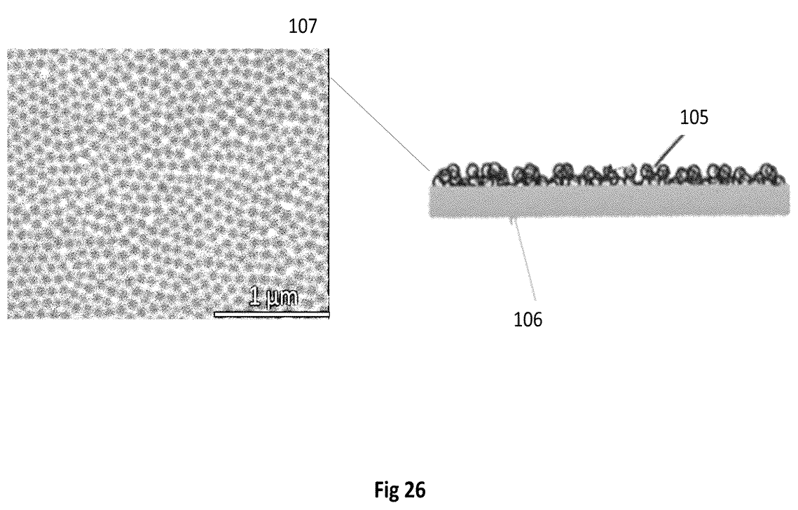

FIG. 26 is an illustration of one embodiment of the present invention that shows ordered arrays of magnetized metal nanoparticles 105 with large area of coverage on a substrate metallic surface 106. The nanoparticles show on a sectional view of the substrate material, not to scale, are pre-oriented to specific magnetic poles such that areas of the surface substrate covered by said nanoparticles exhibit a north magnetic pole while other areas, south magnetic poles in order to produce a specific pattern of a magnetic field arrangement.

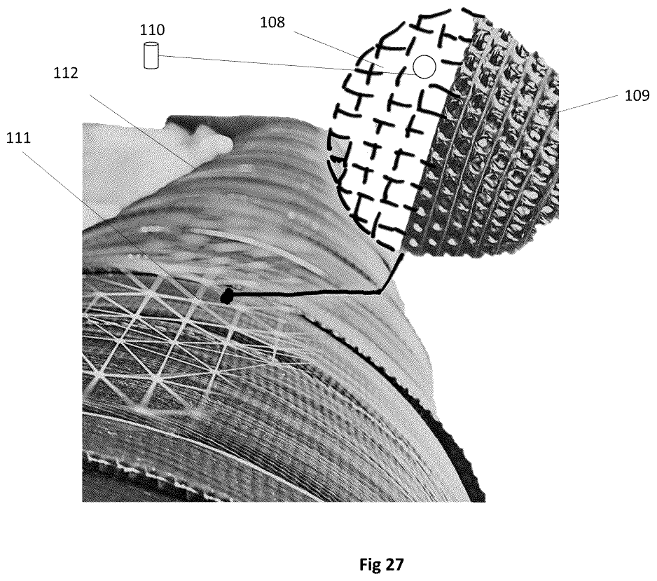

FIG. 27 is an illustration representing one embodiment of the present invention showing a metallic pipeline 112 covered with a wrapping coating such that the wrapping coating comprises a base layer of holed membrane 108 and a sensor layer 109 on top only. The base layer provides holes, such as the sockets of FIG. 24 layer 93, which are used to keep mechanically in place micron-sized magnets 110 (illustrated as top view and isometric view in this illustration). These magnets 110 are oriented in specific patterns of magnetic pole orientations such that certain areas have north and others south magnetic poles. Said magnetica pole orientation deployed on the pipeline surface is used to manifest changes in the magnetic field produced by the magnets which are caused by nano displacements of mechanical waves traveling on the material in any of the displacement axis, meaning the hoop direction, longitudinal and the direction perpendicular to the pipe wall thickness. The changes of magnetic field angle and strength are detected by hall effect sensors mounted on the top sensor layer 109. (the hall effect sensors are not shown in this illustration).

The disclosed embodiments are merely exemplary of the invention that may be embodied in various and alternative forms.

In the preferred embodiment, the device of the present invention consists of layers of materials, each comprising solid and flexible pieces linked to each other by mechanical linking parts. In this embodiment, the pieces carry electronic printed circuits that interconnect electronic components to provide sensing, microprocessor and communication functions. In this embodiment, the structure under monitoring is located underground, for example a buried pipeline. The upper layer of the device which is in contact with the soil provides pieces equipped with a plurality of sensors for detecting various physical or chemical parameters of the soil, including temperature, mechanical pressure, humidity, and chemical properties of the soil. In this embodiment, every piece of the device provide electrical connectors that allow interconnecting every piece to receive and transmit power and communication by means of cable buses which allow the pieces to receive electrical power from other pieces and or external sources, and to allow communicating with other pieces to exchange data among themselves and to communicate with external equipment. In this embodiment, the pieces carry electronic printed circuits containing processors for processing and analyzing data received from
I. sensors mounted on other pieces or
II. sensors mounted on the same piece where the processor is located, or
III. sensor from third-party sources

The processor may be a microcontroller, a microprocessor, or an application-specific integrated circuit (ASIC). In this embodiment, a power supply unit comprising solar panels for harvesting energy from sunlight and batteries for storing the harvested energy is located aboveground and connected to the device by an electrical cable suitable for direct burial. The solar panels may be organic photovoltaic (OPV) or inorganic photovoltaic (IPV) cells. The batteries may be lithium-ion, lithium-polymer, or another suitable type. In this embodiment, the pieces include printed circuits containing communication electronic components for transmitting and receiving data wirelessly from external equipment. In this embodiment, the pieces have printed sensors with printed antenna units. The communication components may support various communication protocols, such as Bluetooth, Wi-Fi, LoRa WAN, or cellular networks.

In this embodiment, the contour sides of the device are linked mechanically to solid bar pieces which are mechanically connected to fastening belts placed around the structure (in this embodiment, a buried pipeline) such that one end of the belt is connected to one bar and the other end of the belt to another bar placed in opposition to the first bar to allow the device to tightly attach itself to the structure. The bars may contain wall thickness probes connected to signal processing printed circuit boards which are connected to the flexible device pieces carrying microprocessors.

In this embodiment, the device is equipped with a shielding cover of a hard material that allow protecting the device from mechanical impact. This shield is equipped with a temperature control system consisting of tubing mounted under it that allows circulation of cooling or anti-freezing fluid to maintain the device at the desired working temperature, thus enabling the device to work in cold or hot underground installations. This shield includes temperature sensors and a temperature controller.

In this embodiment, the pieces located on the upper layer carry printed circuits with screen-printed electrodes (SPEs) embedded with a chemical reference for electroanalytical detection of metal ions in the underground soil surroundings of the device.

In this embodiment, the device includes a lower first layer consisting of a membrane that is attached to the structure such as the membrane is applied as a permanent coating. This membrane contains nano-ink circuits patterns that can generate electromagnetic fields responsive to structural displacements of the surface of the structure, caused by stimuli derived from changes in operating conditions, such as inner pressure, flow-rate of the fluid contained by the structure, the environment and installation conditions. The device contains a second layer consisting of articulated pieces carrying printed circuits with electronic components, capable of executing functions of sensing and processing. In the same embodiment, a piece located on top of the nano-ink circuit pattern on a second layer of the device is equipped with a hall sensor capable of detecting nano-displacements of the surface of the structure. The hall effect circuit of this piece provides compensation for drifts and jitter of the sensor from multiple sources.

### Sources of Disturbances in Hall Effect Sensors

Hall effect sensors may exhibit oscillating or unstable pulse width outputs due to various factors such as electromagnetic interference, mechanical vibrations, or fluctuations in the earth magnetic field. These sources of disturbances can introduce noise and compromise the stability of the sensor's readings, potentially limiting the overall resolution and accuracy of the measurements. To mitigate this issue, conventional methods utilize shielding of the sensor from external electromagnetic influences, ensuring a stable power supply, and employing signal filtering techniques can be crucial in enhancing the performance and reliability of Hall effect sensors in precision applications.

Digital output hall effect sensors operate by detecting changes in magnetic fields, and they are designed to output a logic signal (either high or low) when a magnetic field is present. In the absence of a magnetic field, the output may fluctuate due to noise and other environmental factors. This is known as “noise jitter” and is a common issue with digital sensors. To reduce this noise, manufacturers may implement filtering or other techniques to stabilize the output signal. It's important to note that some fluctuation in the absence of a source magnetic field is normal and expected. However, jitter can affect severely the accuracy and resolution of a hall effect measurement, particularly in nano-scale measurements.

In general, digital output Hall effect sensors often suffer from jitter. There are several sources of noise jitter in hall effect sensors, including magnetic fields from nearby sources that can cause fluctuations in the hall voltage, leading to jitter. Temperature changes can cause variations in the inner clock of the sensor leading to variations in the output voltage. If the power supply to the sensor is not stable, it can introduce noise into the output signal. Any mechanical stress on the sensor can cause variations in the output signal, leading to jitter. Interference from other electronic devices operating nearby can introduce noise into the output signal. Defects in the manufacturing process of the sensor can cause variations in the output signal. Mitigating jitter in Hall effect sensors is essential for achieving stable and accurate readings, especially in applications like position sensing, speed measurement, current sensing and nano-displacements. The current methods for reducing jitter in Hall effect sensors include Low-Pass which smooth out high-frequency noise by limiting the sensor's bandwidth, allowing only low-frequency signals that represent actual changes in position or magnetic field strength and angle or both. Software-based filters (e.g., moving average filters, exponential smoothing, or Kalman filters) can smooth sensor data, reducing jitter without adding physical components. In cases where specific noise frequencies dominate, a notch filter can target and remove these particular frequencies, further stabilizing the output. Averaging and sampling methods help reduce high-frequency noise. Oversampling and decimation, by collecting data at a higher frequency than needed and average it to get a more stable reading. Oversampling can increase resolution and smooth out noise, reducing jitter significantly. Adjusting the sampling rate to avoid interference with specific noise frequencies. Magnet Shielding: External magnetic interference can cause jitter. Adding shielding around the sensor or using a more stable magnetic source can help reduce external noise sources. Alignment of the magnetic source relative to the Hall sensor to avoid misalignment or instability can reduce jitter. Using stronger magnets can reduce jitter caused by minor movements of the sensor or magnet. A stronger magnetic field reduces the sensitivity to external fields and minor vibrations. Power Supply Stabilization by providing a stable and noise-free power supply with voltage regulators or low-dropout (LDO) regulators can mitigate power-induced jitter, as fluctuations in power can directly affect the sensor's signal. If the sensor outputs an analog signal, using shielded cables between the sensor and the processing circuit can reduce electromagnetic interference and signal jitter. Using a differential Hall effect sensor (two sensors measuring the same field but with opposite polarities) can cancel out common-mode noise, thus reducing jitter. Implement algorithms that predict and correct jitter based on historical sensor readings and known patterns. For instance, predictive algorithms can apply adjustments to mitigate random fluctuations. By implementing a combination of these methods, jitter in Hall effect sensors can be significantly reduced, leading to smoother, more reliable sensor outputs. The optimal approach may vary depending on specific application requirements, such as the acceptable level of jitter, speed of response, and environmental constraints.

### Limitations of Current Mitigation Methods

However, Hall effect sensors are sensitive to temperature variations, which can lead to drift and jitter. Daily temperature variations and unexpected fluctuations in the temperature of the structure under monitoring cannot be anticipated. Similarly, fluctuations in the temperature of the surroundings of the measurement device either in underground or above ground installations cannot be entirely anticipated.

The dynamically compensated sensing device of the present invention provides a real-time and dynamical compensation against any external nuisance and noise source resulting in a dynamic cancellation of the disturbances at the sensor output, thus allowing the desired magnetic field from pre-selected magnetic sources to be accurately measured. This compensation is achieved by generating a magnetic field which produces the exact opposite magnetic flux signal to the fluctuating (jitter) signal output of the hall sensor. As a result, the resulting hall sensor output significantly reduces the jitter thus increasing significantly the resolution of displacement and angle of a magnetic flux source.

### OTHER EMBODIMENTS

In another embodiment, the structure under monitoring is a vessel or pipeline installed aboveground containing fluids and the upper layer of the device is in contact with the ambient air and includes a flexible solar panel mounted on top of the structure under monitoring to allow capturing sunlight. Additionally, thermal compensation mechanisms, including serpentine tubing, may be integrated into the mechanical protection layer to provide controlled cooling or heating of the device. The device pieces carry screen-printed electrodes (SPEs) embedded with a chemical reference for electroanalytical detection of chemical ions in the ambient air.

In this embodiment, the upper layer of the device include a display layer for displaying sensor data, device information and allow configuration of system parameters by a human user. In this embodiment, the first insulation layer is in contact with the structure, the second layer hosts the electrical circuits that interconnect the electronic components, the third layer is a flexible fabric to provide mechanical stability to the device, the forth layer is the printed circuit board with pieces that contain electronic components and the fifth layer contains cooling tubing while the sixth layer contains the heat sink layer along with a flexible solar panel module.

In another embodiment, the structure under monitoring is a buried pipeline carrying fluids and the upper layer of the device pieces carry SPEs sensors using materials of organic compounds, mediators and nanoparticles utilized for detecting the presence of a target chemical element, specific chemical species and ions of said species. Additionally, micron-sized magnets arranged in predefined pole orientations may be incorporated within a wrapping membrane layer to provide magnetic field-based structural monitoring using Hall effect sensors. In another embodiment, sealed electronic chips are utilized to allow submersion in fluids, providing environmental protection for sensing and processing components. In yet another embodiment, the sealed chips are embedded in solid materials, integrating them as a part of the structure being monitored. This enables real-time monitoring of internal material properties and integrity while maintaining mechanical stability.

In another embodiment, the structure under monitoring is a biological tissue of human or animal nature and the device pieces located on the first layer in contact with the biological tissue carry SPE based sensors made of biosensors enzymatic chemical, immune and geno and apta-sensors. The SPE based sensors are connected to transducers located in other layers of the device and they are capable of detecting the target chemical element or elements when exposed to their presence. Electrochemical apta-sensors and geno-sensors (i.e. bio-electrochemical sensors) are used as diagnostic tools for rapid, accurate, and cost-effective pathogen detection. In this embodiment, the bio-electrochemical sensors may use nanomaterials, such as gold-based, or carbon-based.

In this embodiment, the bio-electrochemical sensors of the Layer 1 (i.e. lower layer), can detect pathogens in environment such as water, soil, dust, and air. Pathogens that threaten human life and become precursors of deceases to the lower respiratory tract, bloodstream, and stomach, many of them leading to death. In particular, deadly pathogens causing bacterial infections such as Klebsiella pneumoniae, Escherichia coli (E. coli), Streptococcus pneumoniae, Pseudomonas aeruginosa (P. aeruginosa), and Staphylococcus aureus (S. aureus). In yet another embodiment, the bio-electrochemical sensors of the previous embodiment are located on the upper layer as part of wearable pieces such as garments and medical bandages to alert the user about the presence of deadly pathogens. In this embodiment, the lower layers provide data processing, communication and power to the sensing devices by the use of flexible batteries.

### Printed Electrochemical Sensors for Soil Sensing

Electrochemical sensors are employed in soil for real-time monitoring of relevant soil parameters and can be categorized by their detection mechanisms: potentiometric (measuring the electrical potential difference between two electrodes), voltametric (which measures the resulting current from varying the applied voltage), amperometric (measuring the current generated by oxidation or reduction reactions at electrode surfaces), and impedimetric (assessing the impedance to alternating current) sensors. This diversity of sensor types allows measuring of pH levels, presence of chemicals in soil.

### Soil Properties Sensors

The potentiometric sensor can transduce chemical activity into a measurable voltage signal. Ali et al. introduced a nanocomposite of poly(3-octyl-thiophene) and molybdenum disulfide (POT-MoS2) into a working electrode in order to increase electron conductivity and anion exchange rate. The sensors were embedded in soil slurry with a sensitivity of 64 mv/dec for nitrate-nitrogen detection. A nitrate potentiometric sensor with a porosity polyvinylidene fluoride (PVDF) cover allows for direct nitrate measurements in sandy soil and silt loam soil. This allows measuring nitrates at varied water content levels in soil.

### Cyclic Voltammetry

CV is widely used in soil sensing due to its ease of interpretation in detecting the oxidation and reduction of different molecular species and transfer-initiated chemical reactions. The logic solver of the present invention measures the potential in the forward direction, a solution containing the reduced form of a redox couple undergoes oxidation. Next, the logic solver reverses the potential, resulting in the reduction of the oxidized solution back to its reduced form. The peak current observed in CV is a result of analyte species diffusion, which happens when the analyte is depleted on the electrode surface. The peak current changes proportionally with the concentration of the analyte, as described by the Randles-Ševčik equation.

$${i}_{p} = 0.4463 {nFAC ( \frac{nFvD}{RT} )}^{\frac{1}{2}}$$

ip=current maximum in amps
n=number of electrons transferred in the redox event (usually 1)
A=electrode area in cm2
F=Faraday constant in C mol-1
D=diffusion coefficient in cm2/s
C=concentration in mol/cm3
v=scan rate in V/s
R=Gas constant in J K-1 mol-1
T=temperature in K

The constant with a value of 2.69×105 has units of C mol-1 V-1/2 Printed sensors for ion detection in soil using voltammetry. The reference electrode was fabricated using silver/silver chloride (Ag/AgCl), and the working and counter electrodes were fabricated using carbon paste, onto which cadmium sulfide nanorods were drop-casted

In this embodiment, the piece contains a multi-sensor array that can measure potassium concentrations in soil along with other parameters such as nitrate levels, pH, and temperature.

As mentioned at the start, the existing sensing and monitoring technologies present various challenges, including limited flexibility, single-function sensing capabilities, reliance on adhesive-based attachment methods, and lack of real-time multi-directional data processing. The present invention addresses these limitations by introducing a mechanically interlinked, multi-layered sensing system that combines flexible and solid pieces, advanced sensing modules, and intelligent data processing capabilities. Unlike conventional flexible sensor arrays that operate as single-layered adhesive sheets, this invention features independently assembled layers with mechanical articulation, allowing for adaptive configurations, enhanced durability, and seamless integration into complex structures.

Furthermore, traditional pressure or bio-monitoring sensors are often limited to single sensing functions, whereas the present invention incorporates multi-functional sensor networks, including wall-thickness measurement, pressure wave transmission, flow-rate estimation, temperature sensing, chemical detection, and real-time structural diagnostics. This enables comprehensive integrity assessments for pipelines, process vessels, civil infrastructure, and industrial machinery.

Additionally, conventional flexible sensing solutions lack active cooling mechanisms, electromagnetic shielding, and contactless power transfer, which are essential for sustained operation in harsh industrial and environmental conditions. The present invention overcomes these challenges through integrated cooling layers, nano-ink conductive traces, electromagnetic coupling for data and power transmission, and self-sustaining energy generation via solar panels.

By combining multi-layered structural adaptability, modular sensor interconnectivity, and intelligent processing algorithms, the present invention provides an advanced, scalable, and industrially robust solution for real-time structural health monitoring and predictive analysis, effectively overcoming the shortcomings of prior technologies.

### Methods for Flow Rate Measurement

The propagation of electromagnetic waves through a medium like a liquid-filled pipe can be described using Maxwell's equations and the wave equation:

$${∇}^{2} E - μϵ \frac{{\partial }^{2} E}{\partial {t}^{2}} = 0$$

Where ∇² is the Laplacian operator (describes spatial variation).
E is the electric field vector of the wave
μ is the permeability of the liquid-filled pipe.
ϵ is the permittivity of the liquid.
t is time.

The complete wave equation becomes

$$E ( z , t ) = {E}_{0} sin ( \frac{m π x}{a} ) sin ( \frac{n π y}{b} ) {e}^{j ( wt - βz )}$$

Where
   E₀ is the amplitude.
   (x,y) are the transverse coordinates.
   (a,b) are the pipe's dimensions.
   z is the direction of propagation along the pipe.

Since the wave is confined to a pipe, the modified wave equation becomes:

$$( {Δ}_{t}^{2} + {β}^{2} ) E = 0$$

∇²ₜ is the transverse Laplacian (variation across the pipe's cross-section).
β is the propagation constant, related to frequency fand the medium's properties

The liquid flows, it introduces a Doppler-like shift in the frequency of the wave.

The new observed frequency in the moving medium becomes:

$${f}^{′} = f ( 1 \pm \frac{{v}_{f}}{{v}_{p}} )$$

Where
v_{f} is the fluid flow velocity
vₚ is the phase velocity of the wave in the stationary liquid. The sign depends on whether the flow is in the same or opposite direction of the wave.

### Change in Propagation Constant (β)

The equation of propagation constant β is:

$$β = \sqrt{{μϵ w}^{2} - {k}_{c}^{2}}$$

For example in pipelines applications in the range liquid and gas transportation of fluids at room temperature (20-25° C.) and for microwave frequencies (e.g., 2.45 GHz) v_{f}, being the velocity of the fluid is much smaller than vₚ (the phase velocity of the wave in the stationary liquid) For example, at the above conditions, vₚ in water is:

$${v}_{p} \approx 33.9 million m / s ( 3.39 \times {10}^{7} m / s )$$

Hence, the change in the propagation constant allows utilizing certain approximations, thus:

$$Δβ \approx \frac{w}{{v}_{p}^{2}} {v}_{f}$$

Hence, the changes in the propagation constant of microwaves travelling in fluids in conduits allows measuring flow rate.

Another manifestation of the fluid velocity takes place on the boundary layer pipewall-to-fluid, which produces modifications in the dielectric constant, which produces changes in the propagation of microwaves through changes in the propagation constant.

$$β = w \sqrt{{μϵ}_{r}}$$

small changes in εᵣ due to fluid velocity can cause measurable effects such as:
Phase shifts
Amplitude attenuation
Frequency shifts (Doppler effect)

In another embodiment, the multilayer assembly wrapped around a pipeline and having a plurality of solid and flexible chips of electronic circuits which provide specific solid state chips capable of transmitting microwaves and other microwave receiving chips, being both types component parts of the same assembly as shown in FIG. 10, allows measuring flow rate by exploiting the doppler effect. In this embodiment, the microwave travels across the fluid and the pipe-wall and it is received by another chip located on the opposite direction of the transmitting chip, having both transmitting and receiving chips mounted on the same multilayer assembly, as shown in FIG. 10. In another embodiment, a pair of microwave transmitting and receiving chips as shown in FIG. 10, allow measuring changes in the dielectric constant in the boundary conditions of pipe wall-fluid which produce measurable effects in phase shifts, attenuation and frequency shifts measured by the receiving chip of the multilayer assembly of FIG. 10.

In another embodiment, the multilayered device of the present invention provides a flexible ultrasonic phased array connected to the chip of FIG. 25 which provides the wave signals and executes signal detection algorithms by a local microprocessor. The flexible phased array device produces the ultrasonic waves by receiving the wave signals from the chip of FIG. 25, which allows measuring wall thickness of structures such as pipelines and vessels. The flexible phased array device is built in one of the layers of the multilayered device of the present invention and connected electrically to the chip of FIG. 25 by means of flexible wires which connect to the electrical electro-mechanical connectors 96 of the chip of FIG. 25.

Although only a few embodiments of the invention have been described in detail above, those skilled in the art will readily appreciate that many modifications are possible in the example embodiments without materially departing from this invention. Alternatively, the solar electric power may be replaced by long-life rechargeable batteries.

Accordingly, all such modifications are intended to be included within the scope of this disclosure as defined in the following claims.

1. An arrangement comprising:
a plurality of flexible pieces, wherein the flexible pieces are independently assembled and embedded with electronic components including solid-state sensors, microprocessors, and communication circuits interconnected via flexible conductive materials, and wherein the flexible pieces include mechanical linking elements that interconnect with adjacent flexible and solid pieces, permitting rotation about three-dimensional axes;
a plurality of solid pieces, wherein the solid pieces incorporate microtubes arranged in geometric patterns, the microtubes being configured to facilitate the flow of coolant or anti-freezing fluid to dissipate heat generated by electronic components mounted on the solid pieces, or to maintain operational temperatures in freezing conditions, and wherein the solid pieces include optional heat-conductive layers shaped in pyramid patterns to increase heat dissipation efficiency by enhancing contact area with surrounding materials;
a plurality of linking pieces, wherein the linking pieces mechanically interconnect the flexible and solid pieces, and wherein the linking pieces are further configured to enable data communication via electromagnetic coupling between sending and receiving units mounted on the linking and main pieces, and to provide contactless power transfer between adjacent pieces using integrated contactless power units;
screen-printed electrodes (SPEs) embedded within the flexible and solid pieces, wherein the SPEs are configured for electroanalytical detection of target elements, ions, or species in air, soil, or other environmental contexts, and wherein the SPEs utilize organic compounds, mediators, and nanoparticles for chemical detection or are configured as biosensors, enzymatic sensors, immunosensors, genosensors, or aptasensors;
molecule proximity detectors integrated into the flexible and solid pieces, wherein the molecule proximity detectors are based on molecularly imprinted polymers (MIPs) and are capable of detecting specific molecules in liquids, including microbial presence responsible for initiating corrosion;
sealed capsules forming a part of the solid pieces, wherein the sealed capsules house electronic circuits and are configured with outward-extending power and data terminals to facilitate communication with other circuits in the arrangement and with external devices; and
an outer covering shield, wherein the outer covering shield provides mechanical protection and insulation against thermal and environmental factors, thereby ensuring the operational integrity of the interconnected pieces under varying conditions.

2. The arrangement of claim 1, wherein power and data wiring are routed through microtubes embedded within the material of the main pieces and terminate at transmitting and receiving interfaces located on the sides of said pieces to enable power and data communication across layers.

3. The piece of claim 1, wherein a capacitive sensor is integrated to detect the proximity of a human operator's finger.

4. The arrangement of claim 1, wherein the pieces are configured in a mechanically independent multilayer arrangement, comprising a top elastic layer providing mechanical protection, impermeability against solids, liquids, and gases, and surface binding properties for target molecules; a flexible isolation layer beneath the interlinked pieces, offering mechanical resistance to deformation and ingress protection, equipped with pass-through holes secured by solid ring clips for electrical connections; and a flexible electrical circuit layer beneath the isolation layer, providing electrical interconnections among the interlinked pieces.

5. The arrangement of claim 1, wherein microtubes are arranged in geometric patterns and constructed from heat-conductive materials, each microtube including an inlet port with a flexible connection for coolant ingress and an outlet port for egress, and wherein the outer surface of the microtubes incorporates magnetized particles oriented uniformly to enable detection of localized deflections using magnetic proximity sensors.

6. The arrangement of claim 1, wherein an RFID device is attached to a piece, enabling retrieval of measurement data and operational status via near-field communication.

7. The arrangement of claim 1, wherein pieces are equipped with a display to visualize measured variables and system integrity, powered through the linking pieces of claim 1.

8. The arrangement of claim 1, wherein flexible pieces include a battery layer configured to power a contactless charging circuit for adjacent pieces.

9. The arrangement of claim 1, wherein solid pieces integrate flash memory units mounted on printed circuit boards, connected to power and data buses through electrical conductors routed to adjacent pieces via linking elements.

10. The arrangement of claim 1, wherein a contactless power transmitting unit is mounted on the upper surface to enable wireless charging of proximate devices.

11. The arrangement of claim 1, wherein a contactless power receiving unit is mounted on a side surface to receive wireless power from adjacent system layers.

12. The arrangement of claim 4, wherein solid pieces are powered by contactless power transmitting units mounted on the flexible circuit layer.

13. The arrangement of claim 1, wherein a capacitive proximity sensor integrated into a solid piece detects nearby solid objects.

14. The arrangement of claim 4, wherein a Hall effect sensor is integrated into a solid piece, and a magnet is attached beneath the stack to detect ferromagnetic materials.

15. The arrangement of claim 14, wherein the arrangement is attached to a ferromagnetic structure such that any surface movement, displacement, or vibration of the structure is detected by the Hall effect sensor.

16. The arrangement of claim 1, wherein flexible pieces include microwave antennas connected to their respective supporting components.

17. The arrangement of claim 1, wherein a printed circuit board of 4G and GPRS communication capabilities is mounted on the solid piece, connected to power, antenna, and data conductors to adjacent pieces of the arrangement of claim 1.

18. The arrangement of claim 1, wherein a printed circuit board of GPS communication capabilities is mounted on the solid piece, connected to power, antenna, and data conductors to adjacent pieces of the arrangement of claim 1.

19. The arrangement of claim 1, wherein a printed circuit board of photovoltaic capabilities is mounted on the solid piece, connected to power, and data conductors to adjacent pieces of the arrangement of claim 1.

20. The arrangement of claim 1, wherein a printed circuit board of programmable microprocessor capabilities is mounted on the solid piece, connected to power, and data conductors to adjacent pieces of the arrangement of claim 1.

21. The arrangement of claim 1, wherein a printed circuit board of 4-20 mA capabilities is mounted on the solid piece, connected to power, and data conductors to adjacent pieces of the arrangement of claim 1.

22. The arrangement of claim 1, wherein a printed circuit board carries an ultrasound probe and transducer mounted on the solid piece, connected to power and data conductors to adjacent pieces of the arrangement of claim 1.

23. The arrangement of claim 1, wherein a printed circuit board carries an ultrasound probe and transducer mounted on the solid piece, connected to power and data conductors to adjacent pieces of an arrangement wherein the pieces are configured in a mechanically independent multilayer arrangement, comprising a top elastic layer providing mechanical protection, impermeability against solids, liquids, and gases, and surface binding properties for target molecules; a flexible isolation layer beneath the interlinked pieces, offering mechanical resistance to deformation and ingress protection, equipped with pass-through holes secured by solid ring clips for electrical connections; and a flexible electrical circuit layer beneath the isolation layer, providing electrical interconnections among the interlinked pieces.

24. The arrangement of claim 1, wherein a printed circuit board of a microphone is mounted on the solid piece, connected to power and data conductors to adjacent pieces of the arrangement of claim 1.

25. The arrangement of claim 1, wherein a printed circuit board carries a watertight camera mounted on the solid piece, connected to power and data conductors to adjacent pieces of an arrangement wherein the pieces are configured in a mechanically independent multilayer arrangement, comprising a top elastic layer providing mechanical protection, impermeability against solids, liquids, and gases, and surface binding properties for target molecules; a flexible isolation layer beneath the interlinked pieces, offering mechanical resistance to deformation and ingress protection, equipped with pass-through holes secured by solid ring clips for electrical connections; and a flexible electrical circuit layer beneath the isolation layer, providing electrical interconnections among the interlinked pieces.

26. The arrangement of claim 1, wherein a millivolt meter sensor printed circuit board is attached to the solid piece to measure the electrical potential between the structure and the surrounding soil to estimate potential for external corrosion.

27. The arrangement of claim 1, wherein sensors measure the surface temperature of the structure where the arrangement is placed.

28. The arrangement of claim 1, wherein the arrangement is attached mechanically around the perimeter of a tubular structure, using non-adhesive fastening means to enable the sensors of claim 1 to measure structural parameters.

29. The arrangement of claim 14, wherein structured magnetic particles sprayed and bonded to the layer material have specific north and south magnetic pole orientations to allow the Hall effect sensor to detect magnetic flux changes.

30. The arrangement of claim 4, wherein it is constructed as a weaved fabric with threads capable of releasing heat when electrical current passes through them.

31. The arrangement of claim 4, wherein it is constructed as a flexible weaved fabric containing microtube threads carrying a cooling fluid to dissipate heat generated by adjacent layers.

32. A strain sensor comprising:
a material surface, wherein the material surface is configured to be attached to a surface to be monitored, and wherein micro-displacements of the monitored surface are manifested on the material surface;
magnetized and polarized ink particles, wherein the ink particles are deposited on the material surface following a predetermined pattern to generate a corresponding magnetic flux pattern;
a Hall effect sensor, wherein the Hall effect sensor is mounted on top of the material surface and is configured to detect variations in the magnetic flux pattern generated by the magnetized and polarized ink particles; and
a dynamically active jitter compensation system, wherein the jitter compensation system comprises an inductor and a phase-shift electrical circuit, the phase-shift electrical circuit being configured to produce a magnetic flux opposed to the jittered sensor output, thereby minimizing Hall effect sensor jitter in the output signal pulse width changes.

33. The strain sensor of claim 32, wherein the material surface is the surface of a structure to be monitored for strain.

34. The strain sensor of claim 32, wherein magnetized ink particles are deposited in predetermined patterns to create unique magnetic flux patterns for strain measurement locations.

35. The strain sensor of claim 32, wherein the jitter compensation system minimizes errors in strain measurements caused by Hall sensor pulse width changes.

36. The strain sensor of claim 32, wherein the magnetic inductance is polarized in opposition to the Hall sensor output signal to reduce fluctuations.

37. The strain sensor of claim 32, wherein magnetized ink particles are deposited using inkjet printing.

38. A method for calculating the inner pressure of a conduit filled with a fluid, wherein the fluid exerts pressure on the conduit material, and wherein the device of claim 1 is attached to the outer side of the conduit, the method comprising:
providing a reference initial inner pressure, wherein the reference inner pressure is entered by a third party into the calculation method, and wherein the reference is defined at a given ambient temperature for a pre-known nominal conduit diameter, conduit wall thickness, and installation conditions, including aboveground or underground installation scenarios;
obtaining a current wall-thickness measurement from a measuring sensor, wherein the measurement is obtained at the given ambient temperature and under the conditions defined by the reference initial inner pressure; and
calculating the inner pressure of the conduit, wherein the calculation is performed using the reference initial inner pressure and the current wall-thickness measurement, and wherein the calculation applies pressure and thermal expansion equations specific to cylindrical-shaped conduits.

39. The method of claim 38, wherein calculated inner pressure is dynamically corrected using intrusive pressure sensors, comprising comparing measured pressures, calculating differences, and using representative differences for error correction.

40. The arrangement of claim 1, wherein a dedicated temperature control system, separate from sensing electronics, regulates the temperature by circulating cooling or anti-freezing fluid, managed by a temperature control microprocessor based on environmental conditions.

41. The arrangement of claim 1, wherein the electronic chips are sealed to allow submersion in fluids, providing environmental protection for sensing and processing components.

42. The arrangement of claim 41, wherein the sealed chips are embedded in solid materials to become an integral part of the structure being monitored, enabling real-time monitoring of internal material properties and integrity.

43. The arrangement of claim 1, wherein a mechanical protection layer comprises a thermal compensation serpentine tubing system to actively regulate temperature through a controlled heating or cooling mechanism.

44. The arrangement of claim 29, wherein the structured magnetic nanoparticles are deposited onto a metallic surface in a predefined north-south pole pattern, enabling magnetic displacement detection via Hall effect sensors.

45. The arrangement of claim 29, wherein a pipeline or vessel wrapping membrane contains micron-sized magnets positioned in predefined pole orientations, allowing Hall effect sensors to detect structural nano-displacements due to material stress, thermal expansion, or external force application.

46. The method of claim 38, wherein the inner pressure calculation further comprises:
a) Receiving strain and temperature data from a sensing layer;
b) Adjusting pressure calculations based on thermal expansion coefficients;
c) Applying a correction factor determined from hydraulic calculations to refine the strain-based pressure model.

47. The arrangement of claim 1, wherein a microwave-based flow rate sensor is integrated into the solid pieces, the sensor comprising:
a) a microwave transmitter and receiver positioned on opposite sides of a fluid conduit;
b) a Doppler shift analysis unit configured to determine fluid velocity based on frequency changes in the microwave signal; and
c) a computational unit that calculates real-time volumetric flow rate using conduit cross-sectional area and fluid velocity data.

48. The method of claim 38, wherein the inner pressure calculation further comprises:
a) obtaining a flow rate measurement from a microwave-based flow rate sensor, wherein the microwave-based flow rate sensor is integrated into the solid pieces, the sensor comprising: a) a microwave transmitter and receiver positioned on opposite sides of a fluid conduit; b) a Doppler shift analysis unit configured to determine fluid velocity based on frequency changes in the microwave signal; and c) a computational unit that calculates real-time volumetric flow rate using conduit cross-sectional area and fluid velocity data;
b) determining dynamic pressure variations using the Bernoulli equation; and
c) refining the inner pressure estimation by incorporating real-time flow rate and temperature-dependent density corrections.

49. The method of claim 38, wherein pressure fluctuations are analyzed in conjunction with flow rate variations to detect structural anomalies, wherein deviations from expected pressure-flow relationships indicate potential conduit wall deformation, leaks, or blockages.

50. The arrangement of claim 47, wherein the microwave-based flow rate sensor operates in conjunction with an ultrasonic sensor to validate flow rate readings, improving accuracy under varying temperature and fluid composition conditions.

51. The arrangement of claim 1, wherein a flexible ultrasonic phased array is embedded in one of the layers of the multilayered device, the phased array being electrically connected to a signal processing chip via flexible wires and configured to generate ultrasonic waves for measuring wall thickness in structures such as pipelines and vessels.

52. The arrangement of claim 51, wherein the signal processing chip executes ultrasonic wave signal detection algorithms using a local microprocessor to analyze wall thickness variations, enabling detection of structural integrity changes, corrosion, or material fatigue in real-time.
